(19) United States
(12) Patent Application Publication
(10) Pub. No.: US 2018/0301049 A1
(43) Pub. Date: Oct. 18, 2018

(54) PERSONALIZED EMBEDDED EXAMINATION DEVICE

(71) Applicant: ZHENGFANG MA, SHANGHAI (CN)

(72) Inventors: ZHENGFANG MA, SHANGHAI (CN); YECHI MA, SHANGHAI (CN)

(73) Assignee: ZHENGFANG MA, SHANGHAI (CN)

(21) Appl. No.: 15/740,943

(22) PCT Filed: Jul. 18, 2016
(86) PCT No.: PCT/CN2016/090263

§ 371 Date: Jun. 9, 2018

(30) Foreign Application Priority Data
Jul. 20, 2015 (CN) 201510427348.3

(51) Int. Cl. G09B 7/00

(52) U.S. Cl. CPC G09B 7/00

(57) ABSTRACT

A personalized embedded examination apparatus includes a server and a network terminal. The network terminal includes a display module, an input module, a first transmission module, and a terminal processor module. The server includes a knowledge point storage module, configured to store specific knowledge point structure of each user, wherein the knowledge point structure includes classifications, labels, and content of knowledge points, and a relationship between knowledge points. The server also includes a second transmission module and a server processor module. The server processor module is configured to: form a personalized examination paper based on each user-specific knowledge point structure stored in the knowledge point storage module, transmit the examination paper to the network terminal by using the second transmission module, receive the answer content from the network terminal, and evaluate learning of a user based on the answer result.

### BACKGROUND OF THE PRESENT INVENTION

### Field of Invention

The present invention relates to an examination apparatus, and in particular, to apparatus carrying out targeted examination in a process of learning knowledge point structures of a user.

### Description of Related Arts

In online learning, knowledge is usually classified. The elementary unit of the entire knowledge system is referred to as a knowledge point. For example, the knowledge point in Baidupedia is also referred to as a vocabulary entry. A logical relationship may exist between a plurality of knowledge points, for example, a parallel relationship, an inclusion relationship, or a causal relationship.

Conventional online learning is knowledge point-based learning. However, knowledge points are basically presented in a form of a text list. For example, in Baidupedia, a user obtains a relevant vocabulary entry by entering a search words. In addition to content of the entry, information about editors, and the like, entries associated with the entry are also displayed on a page in Baidupedia. Such associated vocabulary entries are usually found in the content of the entry and are provided by using network links. The user clicks on a link to enter the vocabulary entry corresponding to the link.

However, an association between such vocabulary entries is very weak, and basically, there is no strong logical relationship because this association is only a link which is established when another entry appears in an explanation of a current vocabulary entry. If the user needs to learn a type of knowledge specially, the user cannot perform learning in a manner such as Baidupedia, because there is no logical relationship between entries that need to be learned, and it is impossible to help the user construct a knowledge system.

Another learning manner is to make knowledge points that need to be learned into courseware and upload the courseware to the Internet. A user downloads the courseware or learns the courseware online. In such a courseware learning manner, the conventional classroom learning is just copied to the network, which is not consistent with the learning manner based on Internet thinking. A learner just passively receives the knowledge points provided by the courseware instead of actively learning the knowledge points and constructing a knowledge system based on these knowledge points. On one hand, such a learning system discourages interest of the learner in active learning. On the other hand, it is quite difficult to help, in such a non-global learning manner, the learner construct a systematic and complete knowledge structure.

The applicant improves the foregoing conventional learning system and provides a learning system based on a knowledge point structure. In this system, a user learns the entire knowledge system based on a knowledge point structure. In addition, in this system, a knowledge point structure of the user may be constructed based on the understanding of the user.

However, the disadvantage of the learning system lies in that a learning effect of a user using the knowledge point structure cannot be effectively tested in a learning process. First, the learning effect of the user needs to be tested in different stages in a long learning process. Second, even if a same knowledge point structure is used for learning, users have different mastery degrees and learning progresses. How to provide targeted examination papers based on such a personalized learning condition to efficiently and conveniently test a learning effect is a technical problem that urgently needs to be resolved at present.

### SUMMARY OF THE PRESENT INVENTION

A brief summary of one or more aspects is given below to provide a basic understanding of these aspects. This summary is not a detailed overview of all conceived aspects and is neither intended to identify crucial or decisive elements of all aspects nor to attempt to define the scope of any or all the aspects. The only objective of the summary is to provide some concepts of one or more aspects in a simplified form as a prelude of a more detailed description that is provided later.

An objective of the present invention is to resolve the foregoing problems and to provide a personalized embedded examination apparatus which can assign personalized topics based on a learning status of each user, and provide the most appropriate evaluation of a learning effect, thereby improving the learning efficiency of the user.

A technical solution of the present invention is that: the present invention discloses a personalized embedded examination apparatus, comprising a server and a network terminal, where

the network terminal comprises:

a display module, configured to display an examination paper on a screen of the network terminal;

an input module, configured to input answer content on the examination paper by a user;

a first transmission module, configured to transmit data between the network terminal and the server; and

a terminal processor module, configured to: receive examination paper information from the server by using the first transmission module, display the examination paper by using the display module, receive the answer content of the user based on the input module, and transmit the answer to the server by using the first transmission module; and

the server comprises:

a knowledge point storage module, configured to store specific knowledge point structure of each user, wherein the knowledge point structure comprises classifications, labels, and content of knowledge points, and a relationship between knowledge points;

a second transmission module, configured to transmit data between the server and the network terminal; and

a server processor module, configured to: form a personalized examination paper based on specific knowledge point structure of each user stored in the knowledge point storage module, transmit the examination paper to the network terminal by using the second transmission module, receive the answer content from the network terminal, and evaluate learning of a user based on the answer result.

According to an embodiment of the personalized embedded examination apparatus consistent with the present invention, the server processor module comprises:

a topic assigning unit for learning process, configured to form a personalized examination paper based on a learning process of each user, where content of the examination paper covers only knowledge points that have been learned by a corresponding user.

According to an embodiment of the personalized embedded examination apparatus consistent with the present invention, the server processor module comprises:

a topic assigning unit for knowledge point structure, configured to form a personalized examination paper based on a knowledge point structure constructed by each user, where content of the examination paper covers only a knowledge point structure that has been constructed by a corresponding user.

According to an embodiment of the personalized embedded examination apparatus consistent with the present invention, the server processor module comprises:

a time sequence topic assigning unit, configured to form a personalized examination paper based on a time sequence of learning different knowledge points by the user, where for knowledge points whose learning time point is earlier than a preset value, understanding of the knowledge points by the user is tested, and for knowledge points whose learning time point is later than the preset value, an effect of memorizing the knowledge points by the user is tested.

According to an embodiment of the personalized embedded examination apparatus consistent with the present invention, the server processor module is further configured to: set the examination paper and perform a process evaluation in a learning process of the user, or set the examination paper and perform a process evaluation after the user completes learning.

According to an embodiment of the personalized embedded examination apparatus consistent with the present invention, the server processor module is further configured to set the examination paper and perform evaluation when the user is to perform a cold start, when the user is to perform a self test, or when external evaluation is to be performed.

According to an embodiment of the personalized embedded examination apparatus consistent with the present invention, the server processor module further comprises:

a setting unit for topic assigning manner, configured to set questions as a test for the knowledge point structure or as a test for the content of the knowledge points.

According to an embodiment of the personalized embedded examination apparatus consistent with the present invention, the question-generation-manner setting unit is further capable of setting questions as a test for understanding of the knowledge point structure or the content of the knowledge points or as a test for a memory effect of the knowledge point structure or the content of the knowledge points.

According to an embodiment of the personalized embedded examination apparatus consistent with the present invention, the server processor module further comprises:

an evaluation unit, configured to: set a weight coefficient based on difficulty of the formed examination paper, and form an evaluation result by integrating the answer result of the examination paper corresponding to the user with the weight coefficient corresponding to the difficulty of the examination paper.

Compared with the prior art, the present invention has the following beneficial effects: In the present invention, targeted examination papers are formed based on specific learning statuses, for example, users have different understandings of the knowledge point structure and different learning progresses in a learning process. Different weight coefficients are set based on different examination papers. At last, an evaluation result is obtained by integrating a completion status of an examination paper of a user and a set weight coefficient. Compared with the prior art, the present invention can detect, in real time and in different stages, learning effects of users in a long time learning process. The detection is personalized for each user and a learning effect of each user can be detected in the most appropriate manner.

### BRIEF DESCRIPTION OF THE DRAWINGS

FIG. 1 is a principle diagram of a first embodiment of a personalized embedded examination apparatus consistent with the present invention.

FIG. 2 is a principle diagram of a second embodiment of a personalized embedded examination apparatus consistent with the present invention.

FIG. 3 is a principle diagram of a third embodiment of a personalized embedded examination apparatus consistent with the present invention.

### DETAILED DESCRIPTION OF THE PREFERRED EMBODIMENTS

The foregoing features and advantages of the present invention can be better understood after reading detailed descriptions of embodiments of the present disclosure with reference to the following accompanying drawings. In the accompanying drawings, various components are not necessarily drawn to scale, and components having similar relevant characteristics or features may have the same or similar reference numerals.

First Embodiment of a Personalized Embedded Examination Apparatus

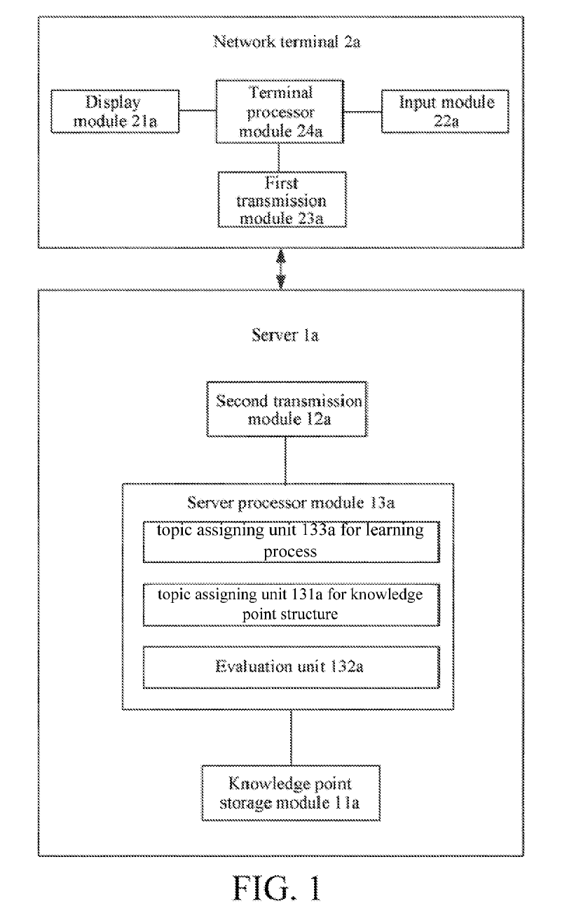

FIG. 1 shows a principle of the first embodiment of the personalized embedded examination apparatus consistent with the present invention. Referring to FIG. 1, the embedded examination apparatus according to this embodiment comprises a server 1a and a network terminal 2a.

The network terminal 2a comprises a display module 21a, an input module 22a, a first transmission module 23a, and a terminal processor module 24a.

The display module 21a is configured to display an examination paper on a screen of the network terminal. The input module 22a is configured to input answer content on the examination paper by a user. The first transmission module 23a is configured to transmit data between the network terminal and the server 1a. The terminal processor module 24a is configured to: receive examination paper information from the server 1a by the first transmission module 23a, display the examination paper by the display module 21a, display the answer content of the user received by the input module 22a, and transmit the answer content to the server 1a by the first transmission module 23a.

The most important operation in the present invention is the forming of the examination paper, this operation is performed in the server 1a. The server 1a comprises a knowledge point storage module 11a, a second transmission module 12a, and a server processor module 13a.

The knowledge point storage module 11a is configured to store specific knowledge point structure of each user, wherein the knowledge point structure comprises classifications, labels, and content of knowledge points and a relationship between knowledge points. The second transmission module 12a is configured to transmit data between the server and the network terminal 2a.

The server processor module 13a is configured to: form a personalized examination paper based on specific knowledge point structure of each user stored in the knowledge point storage module 11a, transmit the examination paper to the network terminal 2a by the second transmission module 12a, subsequently receive an answer from the network terminal, and evaluate learning effect of a user based on an answer result.

Specifically, the server processor module 13a comprises a topic assigning unit 133a for learning process and a topic assigning unit 131a for knowledge point structure. The topic assigning unit 133a for learning process is configured to form a personalized examination paper based on a learning process of each user, wherein the content of the examination paper covers only knowledge points that have been learned by the user.

The topic assigning unit 131a for knowledge point structure is configured to form a personalized examination paper based on a knowledge point structure constructed by each user, wherein the content of the examination paper covers only a knowledge point structure that has been constructed by the user.

The server processor module 13a further comprises an evaluation unit 132a. The evaluation unit 132a is configured to: set a weight coefficient based on difficulty of each examination paper, and form an evaluation result by integrating the answer result of the examination paper corresponding to the user with the weight coefficient corresponding to the difficulty of the examination paper. In this embodiment, knowledge point structures constructed by users vary in complexity and hierarchy. For example, some users have a plain understanding of knowledge point structures or only learn a small number of knowledge points, and therefore, the knowledge point structures constructed by the users have fewer tiers and simpler structures; while some users have a thorough understanding of knowledge point structures or learn a large number of knowledge points, and therefore, the knowledge point structures constructed by the users have more tiers and more complex structures. Because the topic assigning unit 131a for knowledge point structure assigns topics based on the knowledge point structure constructed by each user, obviously, a user who constructs a more complex structure has a more difficult examination paper. In this case, actually, the evaluation unit 132a sets a corresponding weight coefficient based on the construction complexity of a knowledge point structure. A final evaluation result is obtained by multiplying the answer result of the user by the weight coefficient. Therefore, even if an answer score of a user having a simple structure is the same as an answer score of a user having a complex structure, since weight coefficients are different, an evaluation result of the user having the complex structure is superior to an evaluation result of the user having the simple structure.

Preferably, the server processor module 13a is configured to set the examination paper in a learning process of the user, so as to check a staged learning outcome of the user. An occasion for assigning topics may also be set. For example, topics assigning and evaluation may be performed when the user is to perform a cold start on a system, when the user is to start a self test, or when an external organization needs to perform evaluation. Certainly, the server processor module 13a may further be configured to set the examination paper and perform process evaluation after learning is complete, so as to check a final learning outcome of the user.

Second Embodiment of the Personalized Embedded Examination Apparatus

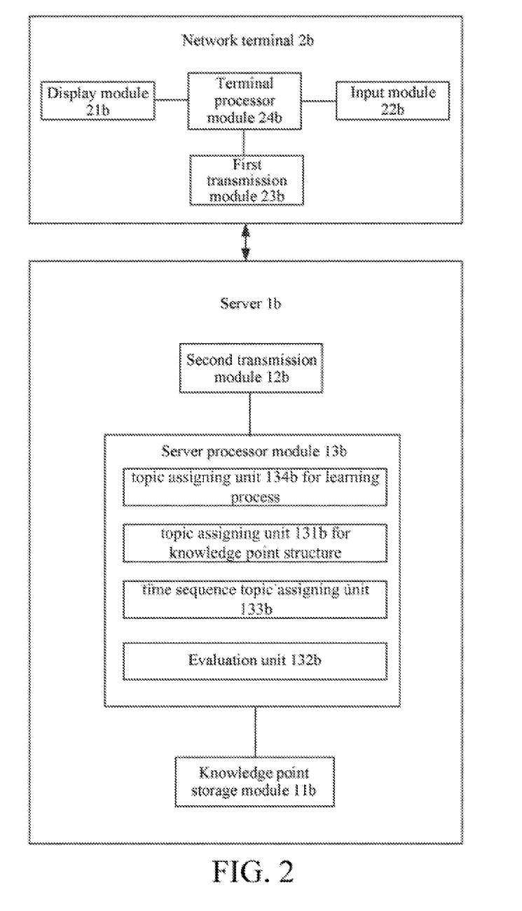

FIG. 2 shows a principle of the second embodiment of the personalized embedded examination apparatus consistent with the present invention. Referring to FIG. 2, the embedded examination apparatus according to this embodiment comprises a server 1b and a network terminal 2b.

The network terminal 2b comprises a display module 21b, an input module 22b, a first transmission module 23b, and a terminal processor module 24b.

The display module 21b is configured to display an examination paper on a screen of the network terminal. The input module 22b is configured to input answer content on the examination paper by a user. The first transmission module 23b is configured to transmit data between the network terminal and the server 1b. The terminal processor module 24b is configured to: receive examination paper information from the server 1b by the first transmission module 23b, display the examination paper by the display module 21b, display the answer content of the user received by the input module 22b, and transmit the answer content to the server 1b by the first transmission module 23b.

The most important operation in the present invention is the forming of the examination paper, this operation is performed in the server 1b. The server 1b comprises a knowledge point storage module 11b, a second transmission module 12b, and a server processor module 13b.

The knowledge point storage module 11b is configured to store specific knowledge point structure of each user, wherein the knowledge point structure comprises classifications, labels, and content of knowledge points and a relationship between knowledge points. The second transmission module 12b is configured to transmit data between the server and the network terminal 2b.

The server processor module 13b is configured to: form a personalized examination paper based on specific knowledge point structure of each user stored in the knowledge point storage module 11b, transmit the examination paper to the network terminal 2b by the second transmission module 12b, subsequently receive an answer from the network terminal, and evaluate learning effect of a user based on an answer result.

Specifically, the server processor module 13b comprises a topic assigning unit 134b for learning process and a topic assigning unit 131b for knowledge point structure. The topic assigning unit 134b for learning process is configured to form a personalized examination paper based on a learning process of each user, wherein the content of the examination paper covers only knowledge points that have been learned by the user. The topic assigning unit 131b for knowledge point structure is configured to form a personalized examination paper based on a knowledge point structure constructed by each user, wherein the content of the examination paper covers only a knowledge point structure that has been constructed by the user.

The server processor module 13b further comprises a time sequence topic assigning unit 133b, configured to form a personalized examination paper based on a time sequence of learning different knowledge points by the user. For knowledge points whose learning time point is earlier than a preset value, because these knowledge points are learned in an earlier time, it is more appropriate to test understanding of these knowledge points by the user. For example, a test is performed by using application topics. For knowledge points whose learning time point is later than the preset value, because these knowledge points are learned in a later time, it is appropriate to test an effect of memorizing of these knowledge points by the user. For example, a test is performed by doze test.

The server processor module 13b further comprises an evaluation unit 132b. The evaluation unit 132b is configured to: set a weight coefficient based on difficulty of each examination paper, and form an evaluation result by integrating the answer result of the examination paper corresponding to the user with the weight coefficient corresponding to the difficulty of the examination paper. In this embodiment, knowledge point structures constructed by users vary in complexity and hierarchy. For example, some users have a plain understanding of knowledge point structures or only learn a small number of knowledge points, and therefore, the knowledge point structures constructed by the users have fewer tiers and simpler structures; while some users have a thorough understanding of knowledge point structures or learn a large number of knowledge points, and therefore, the knowledge point structures constructed by the users have more tiers and more complex structures. Because the topic assigning unit 131b for knowledge point structure assigns topics based on the knowledge point structure constructed by each user, obviously, a user who constructs a more complex structure has a more difficult examination paper. In this case, actually, the evaluation unit 132b sets a corresponding weight coefficient based on the construction complexity of a knowledge point structure. A final evaluation result is obtained by multiplying the answer result of the user by the weight coefficient. Therefore, even if an answer score of a user having a simple structure is the same as an answer score of a user having a complex structure, since weight coefficients are different, an evaluation result of the user having the complex structure is superior to an evaluation result of the user having the simple structure.

Similarly, the evaluation unit 132b may also set the weight coefficient based on a status of forming the examination paper by the time sequence topic assigning unit 133b. Because the difficulty of testing the understanding is higher than that of testing the memory effect, a higher weight coefficient is given to an examination paper emphasizing on testing the understanding.

Preferably, the server processor module 13b is configured to set the examination paper in a learning process of the user, so as to check a staged learning outcome of the user. An occasion for assigning topics may also be set. For example, topics assigning and evaluation may be performed when the user is to perform a cold start on a system, when the user is to start a self test, or when an external organization needs to perform evaluation. Certainly, the server processor module 13b may further be configured to set the examination paper and perform process evaluation after learning is complete, so as to check a final learning outcome of the user.

Third Embodiment of the Personalized Embedded Examination Apparatus

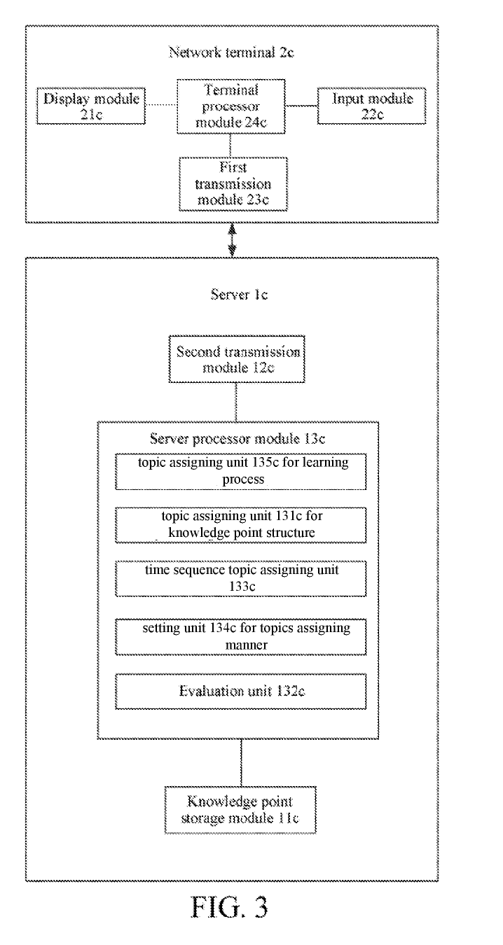

FIG. 3 shows a principle of the third embodiment of the personalized embedded examination apparatus consistent with the present invention. Referring to FIG. 3, the embedded examination apparatus according to this embodiment comprises a server 1c and a network terminal 2c.

The network terminal 2c comprises a display module 21c, an input module 22c, a first transmission module 23c, and a terminal processor module 24c.

The display module 21c is configured to display an examination paper on a screen of the network terminal. The input module 22c is configured to input answer content on the examination paper by a user. The first transmission module 23c is configured to transmit data between the network terminal and the server 1c. The terminal processor module 24c is configured to: receive examination paper information from the server 1c by the first transmission module 23c, display the examination paper by the display module 21c, display the answer content of the user received by the input module 22c, and transmit the answer content to the server 1c by the first transmission module 23c.

The most important operation in the present invention is the forming of the examination paper, this operation is performed in the server 1c. The server 1c comprises a knowledge point storage module 11c, a second transmission module 12c, and a server processor module 13c.

The knowledge point storage module 11c is configured to store specific knowledge point structure of each user, wherein the knowledge point structure comprises classifications, labels, and content of knowledge points and a relationship between knowledge points. The second transmission module 12c is configured to transmit data between the server and the network terminal 2c.

The server processor module 13c is configured to: form a personalized examination paper based on specific knowledge point structure of each user stored in the knowledge point storage module 11c, transmit the examination paper to the network terminal 2c by the second transmission module 12c, subsequently receive an answer from the network terminal, and evaluate learning effect of a user based on an answer result.

Specifically, the server processor module 13c comprises a topic assigning unit 135c for learning process and a topic assigning unit 131c for knowledge point structure. The topic assigning unit 135c for learning process is configured to form a personalized examination paper based on a learning process of each user, wherein the content of the examination paper covers only knowledge points that have been learned by the user. The topic assigning unit 131c for knowledge point structure is configured to form a personalized examination paper based on a knowledge point structure constructed by each user, wherein the content of the examination paper covers only a knowledge point structure that has been constructed by the user.

The server processor module 13c further comprises a time sequence topic assigning unit 133c, configured to form a personalized examination paper based on a time sequence of learning different knowledge points by the user. For knowledge points whose learning time point is earlier than a preset value, because these knowledge points are learned in an earlier time, it is more appropriate to test understanding of these knowledge points by the user. For example, a test is performed by using application topics. For knowledge points whose learning time point is later than the preset value, because these knowledge points are learned in a later time, it is appropriate to test an effect of memorizing of these knowledge points by the user. For example, a test is performed by doze test.

The server processor module 13c further comprises a setting unit 134c for topics assigning manner that may set topics as a test for the knowledge point structure or as a test for the content of the knowledge points. Regardless of the test for the knowledge point structure or for the content of the knowledge points, for a test manner, a test for the understanding or a test for the memory effect may be selected.

The server processor module 13c further comprises an evaluation unit 132c. The evaluation unit 132c is configured to: set a weight coefficient based on difficulty of each examination paper, and form an evaluation result by integrating the answer result of the examination paper corresponding to the user with the weight coefficient corresponding to the difficulty of the examination paper. In this embodiment, knowledge point structures constructed by users vary in complexity and hierarchy. For example, some users have a plain understanding of knowledge point structures or only learn a small number of knowledge points, and therefore, the knowledge point structures constructed by the users have fewer tiers and simpler structures; while some users have a thorough understanding of knowledge point structures or learn a large number of knowledge points, and therefore, the knowledge point structures constructed by the users have more tiers and more complex structures. Because the topic assigning unit 131b for knowledge point structure assigns topic based on the knowledge point structure constructed by each user, obviously, a user who constructs a more complex structure has a more difficult examination paper. In this case, actually, the evaluation unit 132c sets a corresponding weight coefficient based on the construction complexity of a knowledge point structure. A final evaluation result is obtained by multiplying the answer result of the user by the weight coefficient. Therefore, even if an answer score of a user having a simple structure is the same as an answer score of a user having a complex structure, since weight coefficients are different, an evaluation result of the user having the complex structure is superior to an evaluation result of the user having the simple structure.

Similarly, the evaluation unit 132c may also set the weight coefficient based on a status of forming the examination paper by the time sequence question-generation unit 133c. Because the difficulty of testing the understanding is higher than that of testing the memory effect, a higher weight coefficient is given to an examination paper emphasizing on testing the understanding.

Similarly, the evaluation unit 132c may also set the weight coefficient based on a specific topic assigning manner of the setting unit 134c for the topic assigning manner. Because the difficulty of testing the knowledge point structure is higher than that of testing the content of the knowledge points, a higher weight coefficient is given to an examination paper emphasizing on testing the knowledge point structure.

Preferably, the server processor module 13c is configured to set the examination paper in a learning process of the user, so as to check a staged learning outcome of the user. An occasion for assigning topics may also be set. For example, questions may be generated and evaluation may be performed when the user is to perform a cold start on a system, when the user is to start a self test, or when an external organization needs to perform evaluation. Certainly, the server processor module 13c may further be configured to set the examination paper and perform process evaluation after learning is complete, so as to check a final learning outcome of the user.

Persons skilled in the art may further understand that various illustrative logic blocks, modules, circuits, and algorithm steps described with reference to the embodiments disclosed in this specification may be implemented as electronic hardware, computer software, or a combination thereof. To clearly illustrate the interchangeability between the hardware and the software, various illustrative components, blocks, modules, circuits, and steps are generally described above in terms of their functionality. Whether such functionality is implemented as the hardware or the software depends upon a specific application and a design constraint imposed on the entire system. For each particular application, skilled persons may implement the described functionality in different manners, but such an implementation decision should not be interpreted as causing a departure from the scope of the present invention.

Various illustrative logic blocks, modules, and circuits described with reference to the embodiments disclosed in this specification may be implemented or executed by using a general processor, a digital signal processor (DSP), an application-specific integrated circuit (ASIC), a field programmable gate array (FPGA), or another programmable logic device, a discrete gate or a transistor logic, a discrete hardware component, or any combination of those designed to perform the functions described in this specification. The general processor may be a microprocessor, but in an alternative solution, the processor may be any conventional processor, controller, microcontroller, or state machine. The processor may also be implemented as a combination of computing devices, for example, a combination of the DSP and the microprocessor, a plurality of microprocessors, one or more microprocessors cooperating with the DSP core, or any other configurations of this type.

Steps of the method or algorithm described with reference to the embodiments disclosed in this specification may be directly implemented in hardware, in a software module executed by a processor, or in a combination thereof. The software module may reside in a RAM memory, a flash memory, a ROM memory, an EPROM memory, an EEPROM memory, a register, a hard disk, a removable disk, a CD-ROM, or a storage medium in any other forms already known in the art. An exemplary storage medium is coupled to the processor, so that the processor can read information from/write information to the storage medium. In an alternative solution, the storage medium can be integrated to the processor. The processor and the storage medium may reside in the ASIC. The ASIC may reside in a user terminal. In an alternative solution, the processor and the storage medium may reside in the user terminal as discrete components.

In one or more exemplary embodiments, the described functions may be implemented in hardware, software, firmware, or any combination thereof. If implemented as a computer program product in the software, the functions may be stored on or transmitted over a computer-readable medium as one or more instructions or code. The computer-readable medium comprises a computer storage medium and a communications medium, and the communications medium comprises any medium that facilitates transfer of a computer program from one place to another place. The storage medium may be any available medium accessible by a computer. As an example and not limitation, such computer-readable medium may comprise a RAM, a ROM, an EEPROM, a CD-ROM, or another compact disc memory, a magnetic disk memory or another magnetic storage device, or any other medium that can be configured to carry or store expectation program code in a form of an instruction or a data structure and that can be accessible by the computer. Any connection is also appropriately referred to as the computer-readable medium. For example, if software is transmitted from a web website, a server or another remote source by using a coaxial cable, an optical fiber cable, a twisted pair, a digital subscriber line (DSL) or wireless technologies such as infrared ray, radio and microwave, the coaxial cable, optical fiber cable, twisted pair, DSL or wireless technologies such as infrared ray, radio and microwave are comprised in a definition of a medium. As used in this specification, a disk and a disc comprise a compact disk (CD), a laser disk, an optical disc, a digital video disk (DVD), a floppy disk, and a blue-ray disk, where the disk generally magnetically reproduces data, and the disc optically reproduces the data by using laser. Combinations of the foregoing should also be comprised in the computer-readable medium.

The previous descriptions of the present disclosure are provided to enable any person skilled in the art to make or use the present disclosure. Various modifications to the present disclosure are obvious to persons skilled in the art, and the generic principle defined in this specification may be applied to other variants without departing from the spirit or scope of the present disclosure. Therefore, the present disclosure is not intended to be limited to the examples and designs described in this specification, but should be granted the broadest scope consistent with the principles and novel features disclosed in this specification.

What is claimed is:

1. A personalized embedded examination apparatus, comprising a server and a network terminal, wherein
the network terminal comprises:
a display module, configured to display an examination paper on a screen of the network terminal;
an input module, configured to input answer content on the examination paper by a user;
a first transmission module, configured to transmit data between the network terminal and the server; and
a terminal processor module, configured to: receive examination paper information from the server by using the first transmission module, display the examination paper by using the display module, receive the answer content of the user based on the input module, and transmit the answer to the server by using the first transmission module; and
the server comprises:
a knowledge point storage module, configured to store specific knowledge point structure of each user, wherein the knowledge point structure comprises classifications, labels, and content of knowledge points, and a relationship between knowledge points;
a second transmission module, configured to transmit data between the server and the network terminal; and
a server processor module, configured to: form a personalized examination paper based on specific knowledge point structure of each user stored in the knowledge point storage module, transmit the examination paper to the network terminal by using the second transmission module, receive the answer content from the network terminal, and evaluate learning of a user based on the answer result.

2. The personalized embedded examination apparatus as in claim 1, wherein the server processor module comprises:
a topic assigning unit for learning process, configured to form a personalized examination paper based on a learning process of each user, wherein content of the examination paper covers only knowledge points that have been learned by a corresponding user.

3. The personalized embedded examination apparatus as in claim 1, wherein the server processor module comprises:
a topic assigning unit for knowledge point structure, configured to form a personalized examination paper based on a knowledge point structure constructed by each user, wherein content of the examination paper covers only a knowledge point structure that has been constructed by a corresponding user.

4. The personalized embedded examination apparatus as in claim 1, wherein the server processor module comprises:
a time sequence topic assigning unit, configured to form a personalized examination paper based on a time sequence of learning different knowledge points by the user, wherein for knowledge points whose learning time point is earlier than a preset value, understanding of the knowledge points by the user is tested, and for knowledge points whose learning time point is later than the preset value, an effect of memorizing the knowledge points by the user is tested.

5. The personalized embedded examination apparatus as in claim 1, wherein the server processor module is further configured to: set the examination paper and perform a process evaluation in a learning process of the user, or set the examination paper and perform a process evaluation after the user completes learning.

6. The personalized embedded examination apparatus as in claim 1, wherein the server processor module is further configured to set the examination paper and perform evaluation when the user is to perform a cold start, when the user is to perform a self test, or when external evaluation is to be performed.

7. The personalized embedded examination apparatus as in claim 1, wherein the server processor module further comprises:
a setting unit for topic assigning manner, configured to set questions as a test for the knowledge point structure or as a test for the content of the knowledge points.

8. The personalized embedded examination apparatus as in claim 1, wherein the question-generation-manner setting unit is further capable of setting questions as a test for understanding of the knowledge point structure or the content of the knowledge points or as a test for a memory effect of the knowledge point structure or the content of the knowledge points.

9. The personalized embedded examination apparatus as in claim 1, wherein the server processor module further comprises:
an evaluation unit, configured to: set a weight coefficient based on difficulty of the formed examination paper, and form an evaluation result by integrating the answer result of the examination paper corresponding to the user with the weight coefficient corresponding to the difficulty of the examination paper.
